(19) United States
(12) Patent Application Publication
(10) Pub. No.: US 2002/0174593 A1
(43) Pub. Date: Nov. 28, 2002

(54) Fishing lure and a process for creating a fishing lure

(75) Inventor: Juha Siirtola, Heinola (FI)

Correspondence Address: DORITY & MANNING, P.A., POST OFFICE BOX 1449, GREENVILLE, SC, 29602-1449, US

(73) Assignee: Normark Corporation

(21) Appl. No.: 09/862,991

(22) Filed: May 22, 2001

(51) Int. Cl. A01K 85/00

(52) U.S. Cl. 43/42.53

(57) ABSTRACT

The present invention provides for a lure and a method of making a lure that has a metal coating or layer on the interior surface of the lure body. The coating is visible from the exterior of the lure but protected from damage by the lure body.

### FIELD OF THE INVENTION

The present invention relates to fishing lures. More specifically, the present invention relates to a fishing lure having a coating on the interior of the lure body that is visible from the exterior of the lure.

### BACKGROUND OF THE INVENTION

Fishing as a sport is enjoyed around the world. From fresh water to salt water, a wide variety of fish species exist. Fishermen employ a variety of equipment and tackle depending upon the water being fished, the time of day, the species of fish sought, personal choice, and many other factors. A fishing lure, sometimes referred to as an artificial lure, is frequently a part of such equipment and tackle.

Fishing lures are typically designed and decorated with the goal of replicating or mimicking the movement and appearance of a food source for the particular fish being sought. For example, such lure may take on the shape of a minnow, tadpole, frog, mouse, insect, salamander, another fish, or such other food source. The fisherman's hope is that by having a lure closely resembling or acting like a source of food, fish will be enticed into biting the lure.

In an effort to make the lure realistic, a designer can use materials pigmented with the desired colors. For example, colored plastics or rubber may be used. In addition, a designer can paint or stain the external surface of the lure to achieve the desired color and marking characteristics. Decorative features such as scales, eyes, and fins may be painted onto the surface or otherwise added to the lure.

External decorative features, marking, or coloring are subject to damage by chipping or scratching during the use of a lure. For example, typically a lure is tied to fishing line, cast into the body of water being fished, and retrieved by the fisherman. During such use, the lure may come into contact with various debris and structures in the water that can damage the external features of the lure.

### SUMMARY OF THE INVENTION

Objects and advantages of the invention will be set forth in part in the following description, or may be obvious from the description, or may be learned through practice of the invention.

The present invention provides a fishing lure having a coating on the interior surface of the lure body that is visible from the exterior of the lure. By having the coating on the interior, the coating is protected from removal or damage during use and its realistic appearance is increased substantially. In addition, in certain embodiments of the present invention, features can also be added to the interior surface to further increase the realistic effect of the lure while protecting those features from damage or wear.

In one exemplary embodiment of the present invention, a fishing lure is provided that is constructed from a substantially translucent body having an exterior surface that is formed into the overall shape of the lure. The overall shape of the lure may vary as desired. For example, the shape may resemble any one of several fish food sources. The substantially translucent body has an interior surface that defines an interior volume of the body. The interior surface may be textured by any conventional process (i.e. molded) with distinguishing physical fish characteristics. For example, the interior surface may be textured with scales, fins, eyes, legs, or other features as desired. A metallic coating is applied to at least a portion of the textured interior surface so that the fish characteristics are enhanced and visible from the exterior of the substantially translucent body. Any metal may be used in such coating. By way of example only, stainless steel or aluminum may be used as part of the metallic coating. The invention is not limited to any particular process or method for applying such coating.

A loop configured for the receipt of a hook may be connected to the body of the lure. By way of example only, the loop may be constructed from wire or may be formed as part of the body. The loop may be located where desired on the body. Alternatively, the body may be provided with multiple loops positioned as desired along the body. A hook may be attached to any one of the loops. The hook may be of a size and shape as desired for the particular size lure body being used. Optionally, the hook may be a treble hook.

The lure body in one exemplary embodiment may be constructed from a first and a second half joined along at least part of their edges to define the body. The halves may include recesses defining a portion of the interior surface of the lure body and an interior volume for the lure body. In such case, a metallic coating may be applied separately to each recess prior to the halves being joined. The halves may be joined together ultrasonically. Alternatively, other methods may be used including gluing, fusing, or other water tight fit.

The lure body is constructed from a material that allows the body to be substantially translucent. For example, the lure body may be formed from a material such that the lure body is substantially clear. By way of example only, a number of plastics may be used to form the substantially translucent lure body.

The present invention also encompasses a method for forming a fishing lure. The method includes forming a substantially translucent lure body having an exterior surface and an interior surface. Physically distinguishing fish characteristics are defined in the interior surface of the lure body. The interior surface of the body is coated with a metallic material so that the fish characteristics are visibly enhanced from the exterior of the body. The metallic material so used may be aluminum, steel, or any other suitable metal materials. In certain embodiments, the lure body may be formed from opposite halves having fish characteristics defined into the interior sides of the lure body halves. The interior sides of the lure body halves may be coated with metallic material prior to joining the lure body halves together to form the body. The lure body halves of this exemplary embodiment may be joined by ultrasonically welding at least a portion of the edges of the lure body halves together. Alternatively, other methods of joining the lure body halves together may be used including gluing, fusing, press fit, or other water tight fit.

These and other features, aspects and advantages of the present invention will become better understood with reference to the following description and appended claims. The accompanying drawings, which are incorporated in and constitute a part of this specification, illustrate an embodiment of the invention and, together with the description, serve to explain the principles of the invention.

### BRIEF DESCRIPTION OF THE DRAWINGS

FIG. 1 is a perspective view of a lure according to the present invention;

FIG. 2 is a partial cut-away view of the lure illustrated in FIG. 1;

FIG. 3 is an in-line component view of a lure according to the present invention;

FIG. 4 is a diagrammatic illustration of a machine useful for applying a metallic coating to the interior surface of lure body halves according to the invention;

FIG. 5 is a diagrammatic illustration of the metallic coating process that occurs within the machine illustrated in FIG. 4; and

FIG. 6 is a diagrammatic illustration of steps according to a process of the present invention.

### DETAILED DESCRIPTION

Reference now will be made in detail to the embodiments of the invention, one or more examples of which are set forth in the drawings. Each example is provided by way of explanation of the invention, and not meant as a limitation of the invention. For example, features illustrated or described as part of one embodiment may be used with another embodiment to yield still a further embodiment. In fact, it will be apparent to those skilled in the art that various modifications and variations can be made in the present invention without departing from the scope or spirit of the invention.

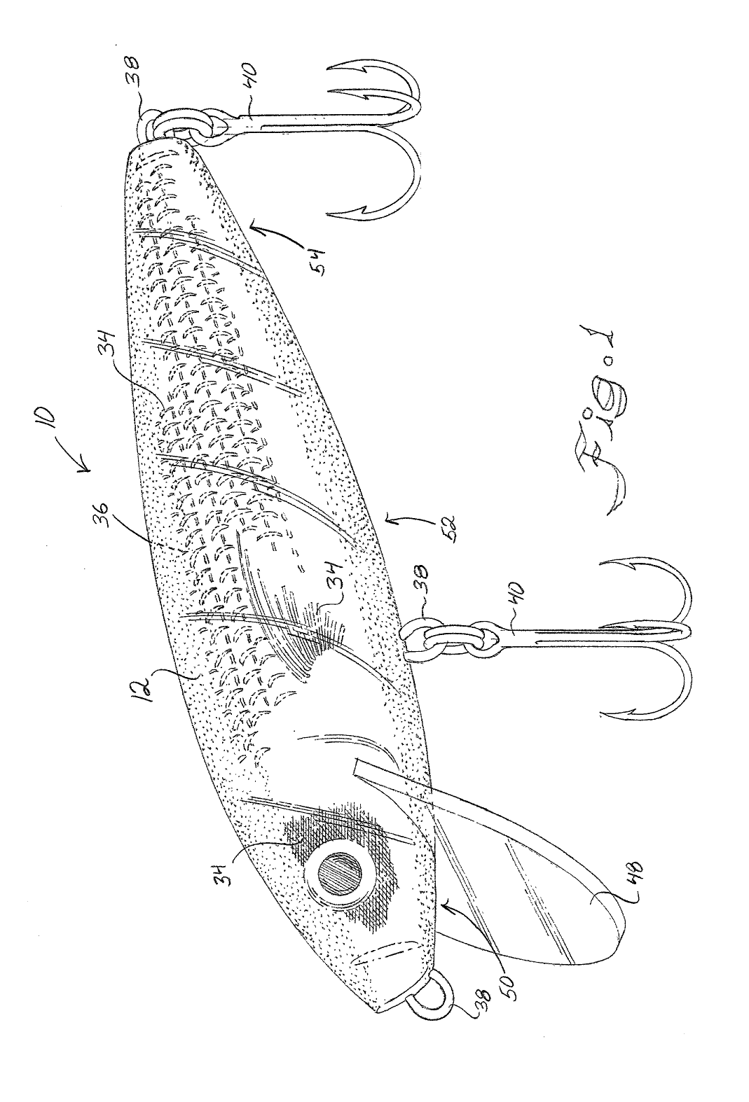

Referring to FIG. 1, an embodiment of a fishing lure 10 according to the present invention is illustrated. The lure 10 includes a body 12 configured in an overall shape of the lure. It should be appreciated that the body and shape of the lure may be configured in various combinations depending on the particular type of lure desired. In the illustrated embodiment, the body 12 has a generally streamlined configuration, and includes a front portion 50, a middle portion 52, and a rear portion 54.

The lure body 12 includes any number or combination of physical fish-like distinguishing characteristics 34. These characteristics may include, for example, scales, gills, fins, eyes, etc. Thus, the term “distinguishing physical fish characteristics” should be understood to include any combination of attributes that give the lure 10 a more realistic and life-like appearance.

The lure body 12 is formed substantially of a translucent material. For example, the body 12 may be formed from a substantially clear plastic material. The lure body 12 has an exterior surface and an internal space or volume 32 defined by an interior surface 22. In one particularly advantageous embodiment, the body 12 is formed by distinct separate halves 14, 18. Each of these body halves may be formed by any conventional process. For example, it may be desired to injection mold the body halves 14, 18 from a substantially clear plastic. Each of the body halves includes a circumferential edge 16, 18.

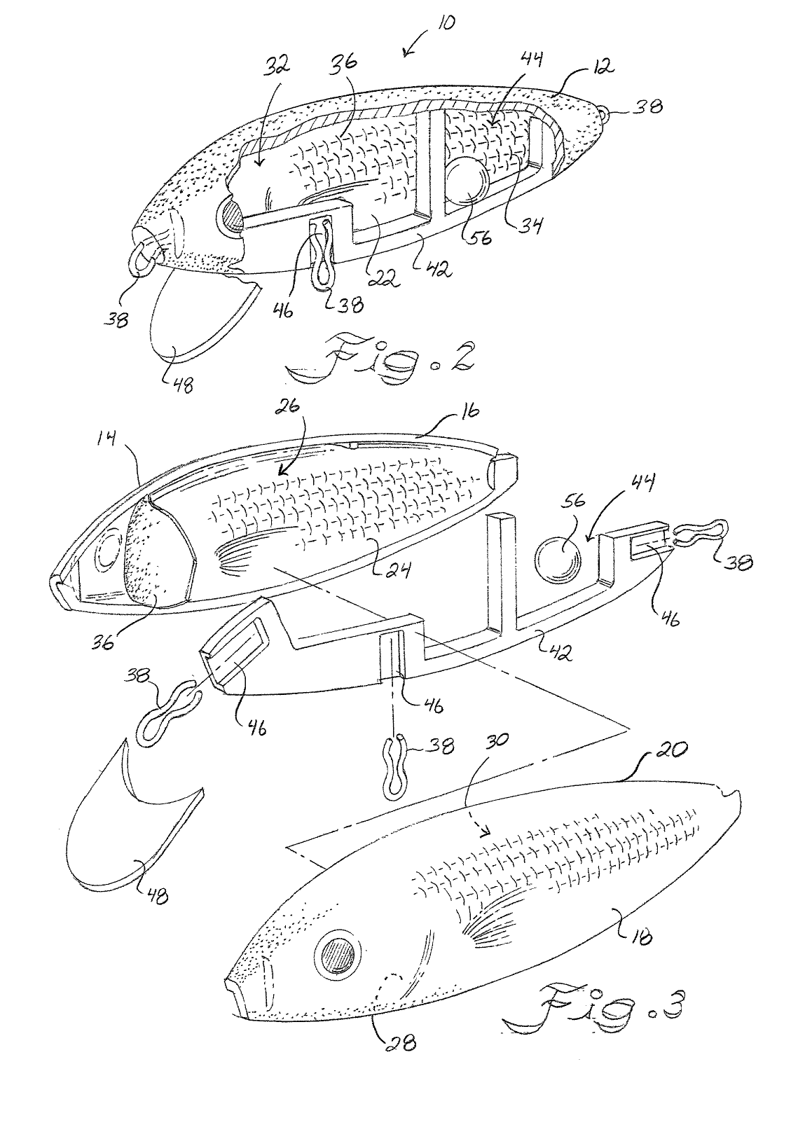

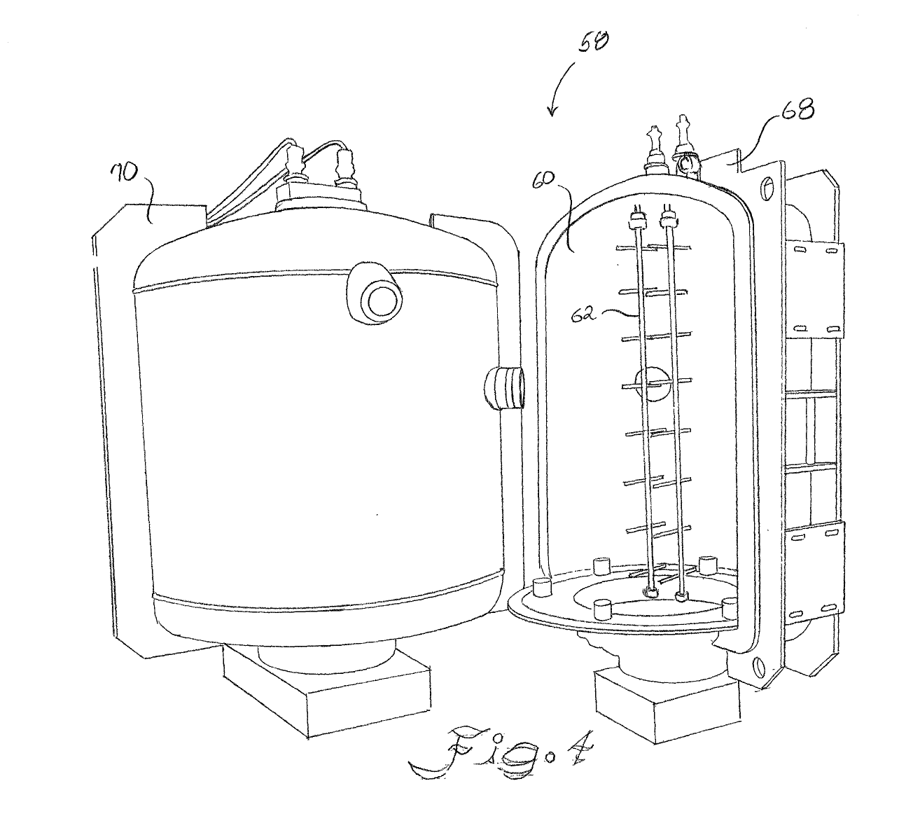

In one particularly desirable embodiment, the body halves 14, 18 define an internal recess or volume. For example, referring to FIGS. 2 and 3, the first body half 14 has a generally concave configuration and defines a first recess or volume 26. Similarly, the second body half 18 defines an internal recess or volume 30. The internal recesses or volumes combine to form the overall internal volume 32 which adds an overall depth and three-dimensional aspect to the end lure product.

Referring to FIGS. 1 through 3 in general, a lure 10 according to the invention includes a metallic coating applied to at least a substantial portion of the interior surface 22 defining the interior volume 32 of the lure body 12. In the example wherein the lure body 12 is defined by separate halves 14, 18, the metallic coating 36 is applied to the interior surfaces 24, 28, of the respective body halves. In this manner, once the body halves 14, 18 are joined together, the interior volume 32 is essentially defined within the metallic coating 36. Since the body 12 is formed of a translucent (and preferentially clear) material, the metallic coating is visible from the exterior of the lure as a three-dimensional component. Because the metallic coating is applied directly to the interior surfaces of the body halves, the coating particularly enhances any of the distinguishing fish characteristics 34 textured on the interior surface 22 of the lure body. Thus, the metallic coating 36, cooperating with the internal configuration of the body lure provides the lure with an enhanced three-dimensional life-like appearance.

Although the physically distinguishing fish characteristics 34 greatly enhance the life-like appearance of the lure 12, such characteristics are not required of all embodiments of the invention. For example, the interior surfaces 24, 28 of the respective body halves 14, 18 may have a substantially smooth or untextured surface. This may be particularly desired to simulate a particular type of bait fish or food source. Even with these types of lures, the metallic coating 36 applied to the rounded concave interior surface of the body halves gives the lure a life-like appearance.

The type of materials used in the metallic coating 36 are not a limiting feature. Although aluminum and steel coatings may prove desirable, the metallic coating 36 may comprise any metal or alloy. Also, it should be appreciated that the metallic coating 36 need not comprise only metal materials. For example, the coating 36 may include an adhesive, epoxy, polymer, and various other materials in combination with metallic components.

In the embodiment of the invention illustrated in FIGS. 2 and 3, the lure 12 may include an internal frame member 42 that is disposed between the body halves 14, 18. The frame member 42 aids in supporting the body halves 14, 18, and provides a devise for attaching loops 38. For example, the loops 38 are easily pressed into loop recesses 46 defined in the frame member 42 at any desired location. The loops 38 may be formed from wire and are particularly configured for receipt of any manner of conventional fish hook 40. The loop 38 disposed at the forward most portion of the lure 10 may be used to attach the lure to a line or leader.

The frame member 42 may also be configured to incorporate various other features. For example, in the illustrated embodiment, the frame member 42 defines a compartment 44 that receives a weight, such as the ball 56. In this configuration, the ball acts as a “rattling” device as the lure is retrieved. Frame member 42 may also be configured to receive a weight that moves longitudinally within the lure body. This configuration is known to those skilled in the art and aids in casting and retrieval of the lure.

The lure 12 may also include any manner of other conventional fishing lure features. For example, in the illustrated embodiment, the lure includes a dive plate 48 that causes the lure to alternately dive and surface as the lure is retrieved.

Referring again to FIGS. 2 and 3, in the embodiment of the lure 12 wherein separate body halves 14, 18 are used to form the end lure product, the body halves each include a circumferential edge 16, 18. The body halves 14, 18 may be adhered by any conventional means or method along their respective circumferential edges. For example, it may be preferred to ultrasonically weld the body halves along the mating edges 16, 20. The invention is not limited in any way by the means or process for attaching the lure body halves.

The present applicant has found that one particularly desirable process for applying the metallic coating 36 is to spray the coating directly onto the interior surfaces of the lure. By spraying the metallic coating 36, it is insured that the coating adequately penetrates into and covers the fish characteristics 34 molded or otherwise previously defined in the interior surfaces 24, 28 of the body halves 14,18.

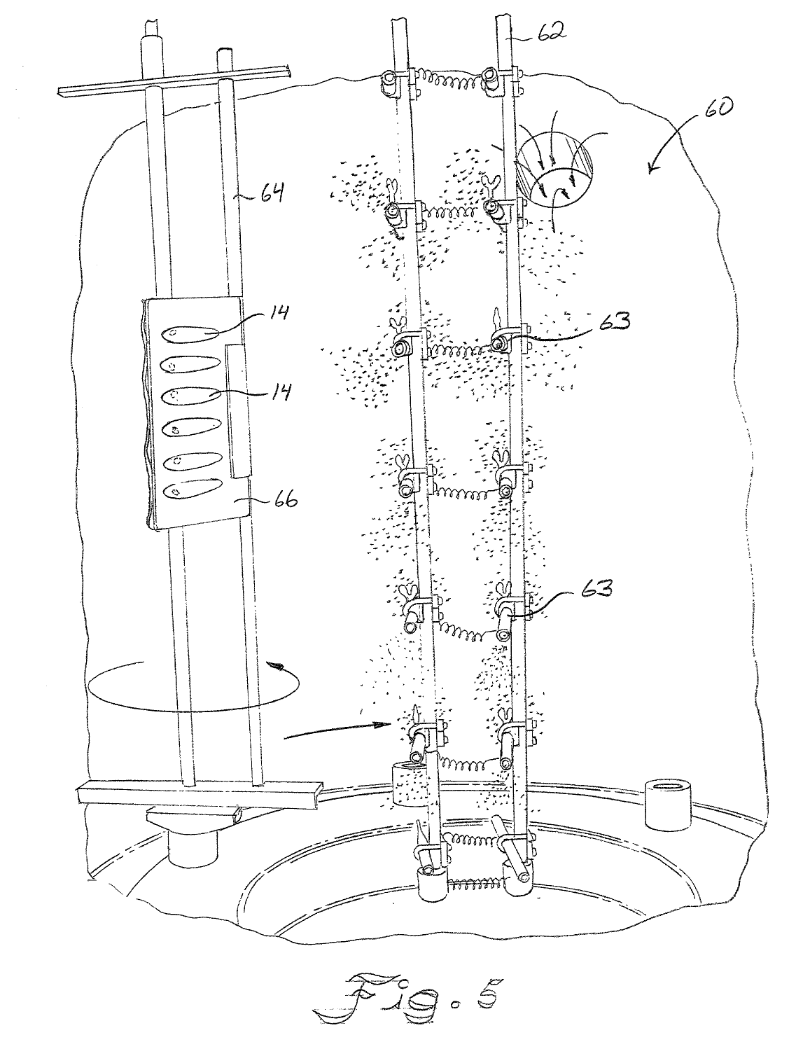

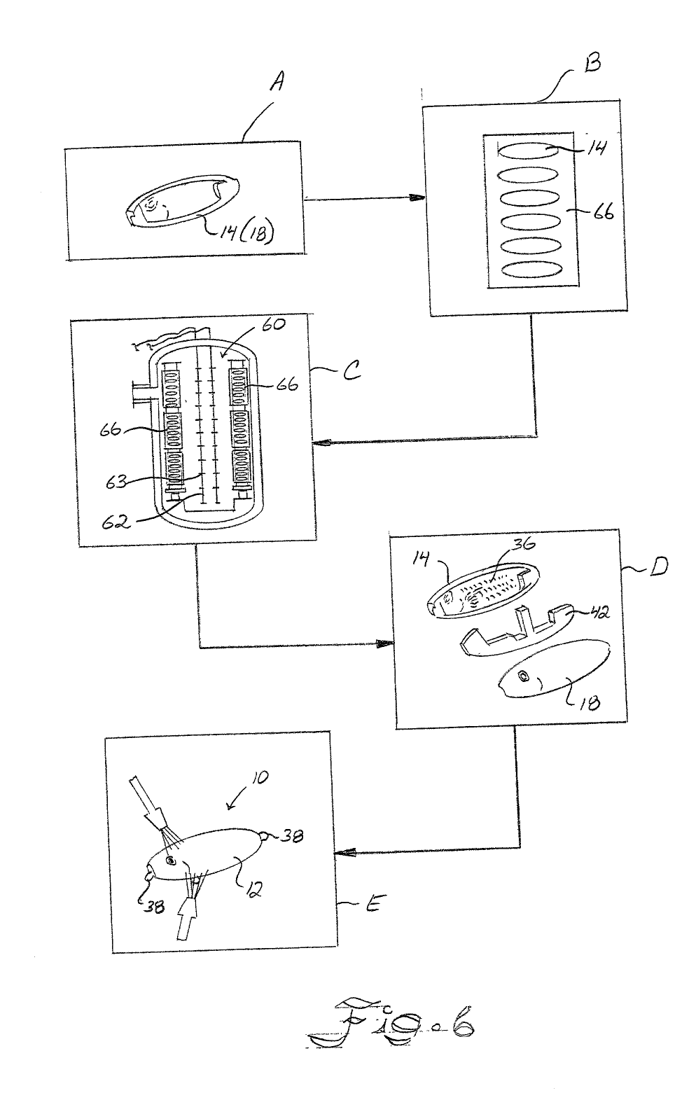

One particularly desirable process for spraying the metallic coating 36 is a vacuum coating process, and in particular a vacuum sputter coating process. This vacuum coating process is particularly useful in coating or metallizing plastic materials. FIG. 4 diagrammatically illustrates a commercially available vacuum sputter coating machine that may be used for producing lures according to the invention. The machine is a GALILEO V201VC industrial vacuum sputter coating machine. This machine is commercially available and its operation is familiar to those skilled in the art of such coating machines. Thus, the operation of the machine need not be described in detail herein. Basically, the machine has separate halves 70, 68 that define an internal vacuum chamber 60. A nozzle frame structure 62 having a plurality of vertically spaced sputter nozzles 63 is provided within the chamber. The structure 62 revolves within the chamber in the direction illustrated in FIG. 5. A plurality of sample stands 64 may be disposed within the chamber. These stands rotate about a fixed axis in the direction illustrated in FIG. 5. The objects to be coated are held or attached to the stands. For example, referring to FIG. 5, the injection molded body halves 14, 18 are placed in trays 16. The trays 16 are in turn connected to the stands 64. Although not visible in the drawings, the interior surfaces of the lure body halves 14, 18 are exposed and the exterior surfaces of the lure body halves are masked or covered. Thus, the interior surfaces of the body lures are uniformly sputter coated with the desired metallic coating within the chamber 60.

As mentioned, the present invention also incorporates a method or process for making a lure. One embodiment of this process according to the invention is diagrammatically illustrated in FIG. 6. In this embodiment, a substantially translucent lure body is first formed having an exterior surface and an interior surface. The step may include forming separate halves of the lure in an injection molding or other suitable process.

Textured physically distinguishing fish characteristics are defined in the interior surface of the lure body. For example, such fish characteristics may be directly molded into the interior surface of the lure body. In the embodiment wherein the process includes molding separate halves of the lure, the fish characteristics may be separately molded directly into the interior surfaces of each body half.

The interior surface of the lure body, for example the interior surface of each respective lure body half, are then coated with a metallic material so that the fish characteristics are visibly enhanced from the exterior of the end lure product. In one particularly desirable embodiment of this step, the separate lure body halves are coated in a vacuum sputter coating process, as depicted in steps B and C of FIG. 6 and described above.

Once the interior surfaces of the lower body halves have been coated, the lure is assembled as depicted in step D of FIG. 6. This assembly process may include configuring a frame member 42 between the lure body halves as discussed above. Also, any other desirable conventional lure features may be included at this step.

FIG. 6 depicts an additional optional step of decorating or otherwise applying finishing touches to the exterior surface of the lure body. For example, distinguishing features may be painted or otherwise attached to the exterior surface of the lure body to enhance the life-like appearance of the lure.

It should be appreciated by those skilled in the art that modifications and variations can be made to the lure and process of manufacturing a lure as described herein, without departing from the scope and spirit of the claims. It is intended that the invention include such modifications and variations as come within the scope of the appended claims and their equivalents.

What is claimed is:

1. A fishing lure, comprising:
a substantially translucent body having an exterior surface formed in an overall shape of the lure, and an interior surface defining an interior volume of said body, said interior surface textured with distinguishing physical fish characteristics; and
a metallic coating applied to at least a portion of said textured interior surface such that said fish characteristics are visible from the exterior of said body.

2. The fishing lure as in claim 1, further comprising a loop connected to said body, said loop configured for receipt of a hook.

3. The fishing lure as in claim 2, further comprising a hook attached to said loop.

4. The fishing lure as in claim 1, wherein said metallic coating comprises aluminum.

5. The fishing lure as in claim 1, wherein said body comprises a first and a second half, said halves joined along at least part of their edges to define said body.

6. The fishing lure as in claim 5, wherein each said half comprises a recess defining a portion of said interior surface and said interior volume, and wherein said metallic coating is separately applied to each said recess prior to said halves being joined.

7. The fishing lure as in claim 5, wherein said halves are ultrasonically joined together.

8. The fishing lure as in claim 1, wherein said body is substantially clear.

9. The fishing lure as in claim 1, wherein said body is formed of a substantially clear plastic material.

10. The fishing lure as in claim 1, further comprising a frame member configured within said body.

11. The fishing lure as in claim 10, wherein said frame member further comprises a loop configured for receipt of a hook.

12. A fishing lure, comprising:
a first body half, and a second body half, each of said body halves being formed from a substantially translucent material and having an exterior surface and an opposite interior surface; a metallic material applied to at least a portion of said interior surfaces; and
wherein said body halves are joined together along at least part of their respective circumferences to define an overall body of the fishing lure.

13. The fishing lure as in claim 12, further comprising at least one hook attached to said body.

14. The fishing lure as in claim 12, wherein said body halves are ultrasonically welded together.

15. The fishing lure as in claim 12, wherein said interior surfaces are defined in recesses of said body halves so that an interior volume is formed in said body.

16. The fishing lure as in claim 12, wherein said metallic material is comprised of steel.

17. The fishing lure as in claim 12, further comprising a frame member disposed in said body between said body halves.

18. The fishing lure as in claim 17, wherein said frame member further comprises at least one loop for receipt of a hook.

19. A fishing lure, comprising:
a lure body constructed from a substantially clear material and having a streamlined shape, said lure body having an interior volume defined by an interior surface and an exterior surface, said lure body having a front portion, middle portion, and rear portion; and
a metallic coating located on the interior surface of said lure body, said layer being visible from the exterior surface of said lure body.

20. A fishing lure as in claim 19, wherein said metallic coating comprised of steel.

21. A fishing lure as in claim 20, wherein said metallic coating comprises aluminum.

22. A fishing lure as in claim 19, wherein said interior surface of said lure body is textured with at least one physically distinguishing fish characteristic.

23. A fishing lure as in claim 19, wherein the rear portion of said lure body further comprises a hook attached to the rear portion.

24. A fishing lure as in claim 23, wherein the middle portion of said lure body further comprises a hook attached to the middle portion.

25. A method for forming a fishing lure, comprising:
forming a substantially translucent lure body having an exterior surface and an interior surface,
defining physically distinguishing fish characteristics in the interior surface of the lure body, and
coating the interior surface of the body with a metallic material so that the fish characteristics are visibly enhanced from the exterior of the body.

26. The method as in claim 25, wherein said coating step comprises applying an aluminum coating to the interior surface of the body.

27. The method as in claim 25, wherein said forming step comprises forming opposite halves of the lure body, said defining step comprises forming the fish characteristics into an interior side of each of the lure body halves, and said coating step comprising coating each of the interior sides of the lure body halves prior to joining the lure body halves to form the lure body.

28. The method as in claim 27, comprising ultrasonically welding at least a portion of the lure body halves together.

29. The method as in claim 27, wherein said coating step comprises spraying the interior surfaces of the lure body halves and while masking the exterior surfaces of the lure body halves.

30. The method as in claim 25, wherein said forming step comprises molding opposite halves of the lure body with the fish characteristics being molded directly into an interior side of each lure body half.

31. The method as in claim 30, wherein the lure body halves are injection molded.

32. A process for creating a fishing lure, the steps comprising of:
creating a lure body having an interior surface and an exterior surface, said lure body being constructed of a substantially clear material;
applying a metal layer to the interior surface of said lure body; and
attaching at least one hook to said lure body.

33. A process for creating a fishing lure as in claim 32, wherein said coating is comprised of aluminum.

34. A process for creating a fishing lure as in claim 32, wherein said substantially clear material is comprised of plastic.
